(19) United States
(12) Patent Application Publication
(10) Pub. No.: US 2021/0295216 A1
(43) Pub. Date: Sep. 23, 2021

(54) SYSTEM AND METHOD FOR PARKING LOT MANAGEMENT

(71) Applicants: Mingkai Li, Torrance, CA (US); David Hernandez, Buena Park, CA (US); Jessica Hilario, Buena Park, CA (US)

(72) Inventors: Mingkai Li, Torrance, CA (US); David Hernandez, Buena Park, CA (US); Jessica Hilario, Buena Park, CA (US)

(21) Appl. No.: 16/827,567

(22) Filed: Mar. 23, 2020

(51) Int. Cl. G06Q 10/02; G06Q 20/10; G06Q 40/02; G06Q 20/32; G06Q 10/06; G07B 15/02; G06Q 30/02; G06Q 30/00; G06K 7/14; G06K 19/06; G08B 21/18

(52) U.S. Cl. CPC G06Q 10/02; G06Q 20/108; G06Q 40/02; G06Q 20/3223; G06Q 20/3267; G06Q 10/06315; G06Q 2220/00; G06Q 30/0284; G06Q 30/0185; G06K 7/1417; G06K 19/06037; G08B 21/18; G06Q 2240/00; G07B 15/02

(57) ABSTRACT

A smart parking space and parking lot management system and method is disclosed. The system includes a parking management server, an attendant system, a plurality of smart parking spots, and an application on a driver's mobile device. Users make reservations on their mobile devices that communicate with the server over the internet. The driver checks in to the attendant system using a QRcode when arriving at the parking lot. The smart spot device informs the system when the vehicle arrives and leaves and may determine if a vehicle is in a proper spot with a reservation. Once the driver returns to the vehicle, payment for the parking is made via the application on the mobile device and the driver may leave the parking lot.

### TECHNICAL FIELD

This application relates in general to a system and method for parking lot management.

### Background

Prior management systems that have being implemented in modern parking structures provide visual guidelines of open spots with elapsed time tracking services. However, users still have to physically be in the parking structures in order to find the empty parking space, as they do not have access to the information beforehand if there is/are any parking spaces available. The present invention attempts to address the existing limitations in supporting an improved parking management system according to the principles and example embodiments disclosed herein.

One past solution to the problem is a concept called “Smart Parking” that involves a sensor that determines parking spot availability and indicates its status with a LED light (visual guidelines). Time parked is tracked by parking validation and works with a ticket given by a machine that is to be returned to a machine to keep track of time parked.

### SUMMARY

In accordance with the present invention, the above and other problems are solved by providing a system and method for parking lot management, and more specifically for providing an online smart parking system.

In one embodiment, the present invention is a parking lot management system managing a plurality of parking spots in one or more parking facilities. The system includes a management server, an attendant processing system, a plurality of parking space devices, and a customer parking mobile application.

The customer parking mobile application communicates with the management server to make a reservation for a parking spot from available spots, receives QRCode data when the driver arrives at one of the one or more parking facilities, communicates check in data and the QRCode data to the management server, and communicates check out and payment information to the management server when departing the one of the one or more parking facilities. The parking space devices having parking space sensors, a signage display, and a status light.

In another embodiment, the present invention is a method for providing parking lot management. The method receives a reservation request from a customer parking mobile application, determines one or more available parking spots matching the reservation request, reserves an available parking spot, receives a QRCode and an arrival time from the customer parking mobile application, determines the vehicle in the reserved parking spot corresponds to a vehicle registered within the customer parking mobile application, receives a departure request and departure time from customer parking mobile application, determines a parking fee using the arrival time and departure time for the reservation, and processes payment for the parking fee using payment data received from customer parking mobile application. The QRCode data is read by the customer parking mobile application at a parking facility corresponding to the reserved parking spot;

The great utility of the invention is that a system and method for parking lot management assists drivers' actions of searching, reserving, parking and paying for a parking spot online, hence the online smart parking system. The online smart parking system assigns an encrypted ID for each user as well as their vehicles, utilizing a real time location tracking feature to give suggestions on closest available parking spots. The system allows users to reserve parking spots at a desired parking structure, and scans the user as well as the vehicle ID upon entry by QR code (or other means). Each spots will be guarded with a microcontroller with sensors that verifies the users' identity upon parking and provides a timing feature to calculate elapsed parking time as well as amount due for payment. The online smart parking system stores and manages available parking lots, reservations, vehicle ids, and elapsed parking time under the program.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 illustrates one potential embodiment a smart parking space according to the present invention.

FIG. 2a-b illustrate potential views from within a smart parking space according to the present invention.

FIGS. 3a and 3b illustrate a schematic of a distributed computing system for implementing a smart parking space and parking lot management system according to the present invention.

FIG. 4 illustrates a flowchart for operating steps for a customer using a smart parking space and parking lot management system according to the present invention.

FIG. 5 illustrates a flowchart for operating steps for a parking lot system using a smart parking space and parking lot management system according to the present invention.

FIG. 6 illustrates a generalized schematic of a programmable processing system utilized as the various computing components described herein used to implement an embodiment of the present invention.

### DETAILED DESCRIPTION

This application relates in general a system and method for parking lot management, and more specifically for providing an online smart parking system.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps, or components but do not preclude the presence or addition of one or more other features, steps, or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “50-250 micrometers should be interpreted to include not only the explicitly recited values of about 50 micrometers and 250 micrometers, but also include individual values and sub-ranges within the indicated range. Thus, included in this numerical range are individual values such as 60, 70, and 80 micrometers, and sub-ranges such as from 50-100 micrometers, from 100-200, and from 100-250 micrometers, etc. This same principle applies to ranges reciting only one numerical value and should apply regardless of the breadth of the range or the characteristics being described.

As used herein, the term “about” means that dimensions, sizes, formulations, parameters, shapes and other quantities and characteristics are not and need not be exact, but may be approximated and/or larger or smaller, as desired, reflecting tolerances, conversion factors, rounding off, measurement error and the like and other factors known to those of skill. Further, unless otherwise stated, the term “about” shall expressly include “exactly,” consistent with the discussion above regarding ranges and numerical data.

The term “user” and “driver” refers to an entity, e.g. a human, that operates an automobile according to the present invention in order to park a car in a smart parking. For such a user, the terms “user” and “driver” may be used herein interchangeably.

Highly populated cities are always booming with the amount of traffic that occurs throughout the years and will only continue to grow as time goes on by. With so many cars, there are way too many cases in which trying to find a place to park your car, an action that should only take a few minutes to complete, can consume up to 30-45+ minutes.

A system and method that assists drivers' actions of searching, reserving, parking and paying for a parking spot online hence the online smart parking system. The online smart parking system assigns an encrypted ID for each user as well as their vehicles, utilizing a real time location tracking feature to give suggestions on closest available parking spots. The system allows users to reserve parking spots at a desired parking structure, and scans the user as well as the vehicle ID upon entry by QR code (or other means). Each spots will be guarded with a microcontroller with sensors that verifies the users' identity upon parking and provides a timing feature to calculate elapsed parking time as well as amount due for payment. The online smart parking system stores and manages available parking lots, reservations, vehicle IDs, and elapsed parking time under the program.

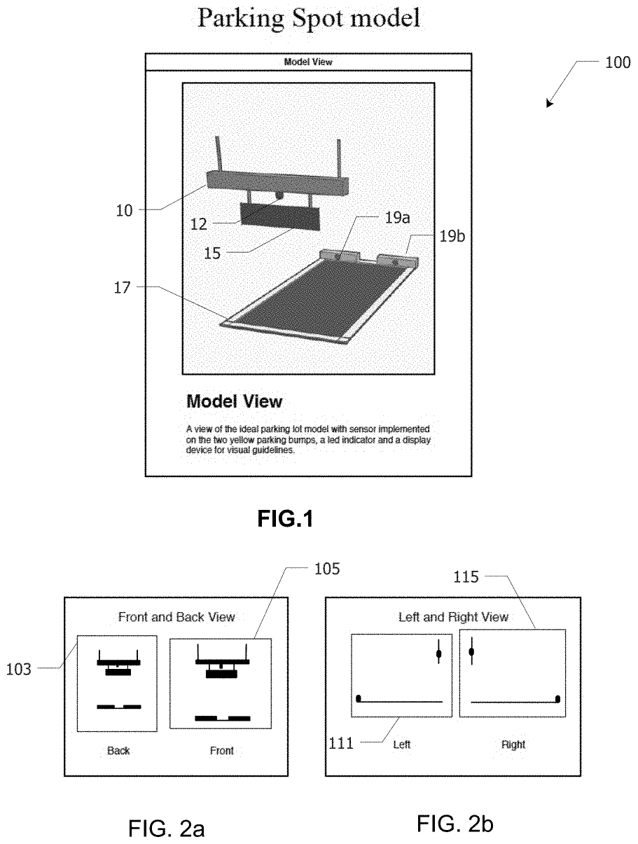

FIG. 1 illustrates one potential embodiment a smart parking space according to the present invention. The smart parking space is made with a parking space 17, wheel sensors 19a-b, parking space identification 10, parking space display 15, and parking space status light 15. A driver will arrange the vehicle into the spot by driving the vehicle onto the parking pad 17. The sensors 19a-b detects the presence of the vehicle in the parking space 17 allowing a parking lot management system to identify which parking spaces are occupied at any given time.

As the vehicle enters the parking space, sensors 19a-b may detect when a vehicle or its tires move into proximity of the sensors to determine when a vehicle is in the space 17. The parking lot management system may detect a time when a vehicle enters a space and again detect when the vehicle leaves the space to determine how long the space was in use. The fee for parking in the space 17 may be calculated using this measurement of time spent therein.

The parking space identification 10 consists of signage that identifies one space from another. When a driver has checked in by scanning a QRCode with a mobile device, license plate information, driver's name information, or similar data may be displayed to permit the driver to locate a parking spot that has been assigned for use by the parking lot management system.

Each parking space 17 is assigned a unique identification ID that is used throughout the process. The driver reserves a parking space 17 over the Internet using a mobile device or computer. The ID for the parking space that has been reserved is sent to the driver so that the parking spot 17 may be found when the driver arrives at the parking lot.

The parking spot display 15 may provide drivers if information concerning the parking spot 17. For example, the parking spot display 15 may indicate if the space is available for use or is reserved for a driver who has not as of yet arrived. When a spot has been reserved, information related to the driver who made the reservation may be displayed. The driver information may include a license plate number for a vehicle included from the mobile device's application that is expected to use the spot during the reservation period. The parking spot display 15 may also provide indication of a time at which an upcoming reservation is to begin. Such information may permit a driver who has not made a reservation to determine if an empty spot 17 may be used if the driver expects to return to leave the parking spot 17 before the start of the next reservation. Other status information pay be provided by a status light 12 such as empty, overstay time, not in assigned spot and the like.

The overall process has a driver make a reservation for a parking spot 17 using a parking application on a mobile device that communicates with the parking lot management system. An available parking spot is set aside for use when the driver arrives at the parking facility. When the driver arrives, a QRCode is available to be scanned by the driver using a QRCode reader that is part of the parking application on the mobile device. This is typically located at an entry point to the parking facility.

The QRcode data is sent by the parking application on the mobile device to the parking lot management system for matching with a previously made reservation. When the parking lot management system connects the arrival of the driver to the reservation, the management system, assigns a parking spot 17 for use. Information to permit the driver to find the assigned spot is sent to the parking application on the mobile device as well as sent to the display 10 at the parking spot 17. The arrival time is noted for billing purposes.

The driver parks the vehicle in the spot 17 and the sensors 19a-b detect the presence of the vehicle. When the driver returns, the parking application on the mobile device is used to signal an end to the use of the parking spot, to provide an end time for the use for billing purposes, and to complete payment using credit card information by the parking lot management system. The sensors 19a-b provide confirmation of the vehicle departing the facility to free the parking spot 17 for use by another vehicle.

If a driver has not made a reservation prior to arriving at the parking facility, a reservation may be immediately made when the QRCode is scanned by the parking application on the mobile device. If a parking spot 17 is available, a reservation is immediately made using user information from the mobile application and the driver's arrival is checked in. The rest of the processing for the parking session continues normally. If the parking lot management system cannot identify an available parking spot when the QRCode is scanned, the driver is informed that a parking spot is not available at the present time and is instructed to seek parking at other facilities. The parking lot management system may recommend available spots at nearby parking facilities, and if accepted by the driver, a reservation for the alternate facility may be made. The driver then proceeds to the alternate facility to check in and park in the normal fashion as described above.

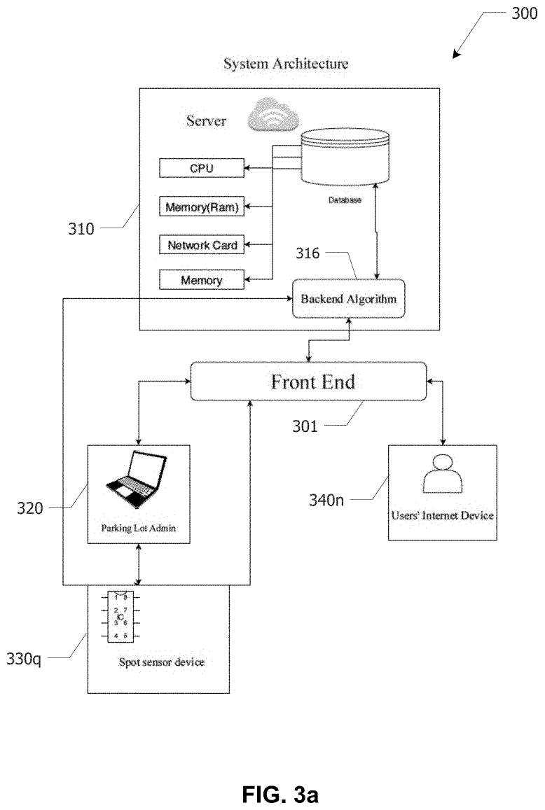

FIG. 2a-b illustrate potential views from within a smart parking space according to the present invention. FIG. 2a illustrates a front view 103 and a rear view 103 of the parking space 17. The display 15, status light 12, and signage 10 are shown in these views along with the sensor 19a-b at tire level. FIG. 2b illustrate side views from a left side 111, and a right side 115 of the parking spot 17.

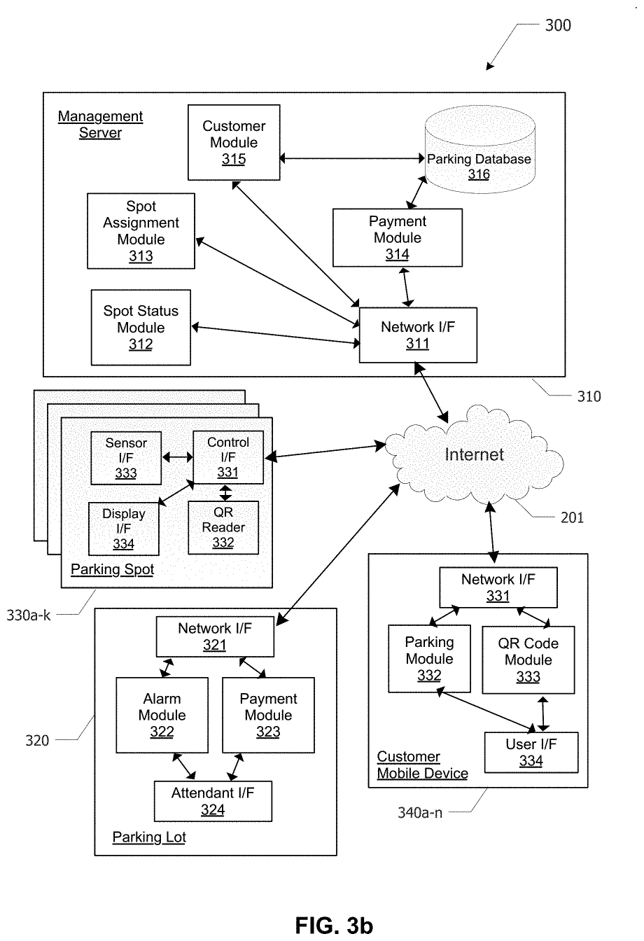

FIG. 3a illustrates a schematic of a distributed computing system for implementing a smart parking space and parking lot management system according to the present invention. The parking lot management system 300 consists of a server 310, a parking lot attendant system 320, a plurality of smart parking spot device 330a-q, and a driver's mobile device 340a-n. Drivers use their mobile devices 340a-n to make a reservation for a parking spot 17 with server 310. The server 310 maintains information of which parking spaces are in use, reserved for future use, and empty. Server 310 receives information from parking spot device 330a-q to determine the state of these parking spots. When a request for a reservation is sent, server 310 identifies an available parking spot 17 that best meets the driver's request. The Server 310 sends information regarding the reserved parking spot 17 to the driver's mobile device 340a-n. The information sent by the server 310 to the mobile device 340a-n include a QRcode that contains encrypted information that may be used to identify a driver when he or she arrives at a parking spot.

The parking lot attendant system 320 operates at each parking lot to process payments when a vehicle leaves a spot 17. The attendant system 320 receives arrival and departure information from the parking spot devices 330a-q and used these time stamps to calculate a parking fee and process payment from driver credit card information maintained by the parking lot management system. The driver's credit card information may be maintained in the mobile device 340a-n and it may be sent when a reservation is made. In other embodiments, the server 310 may also maintain driver identification and payment information obtained when a driver registers to use the parking lot management system.

The parking lot attendant system 320 may also detect when an unregistered vehicle is in a parking spot 17, or when a vehicle has overstayed its reservation, using data from the parking space sensors 19-a-b. In either case, an attendant may investigate the situation to determine whether a vehicle did not simply fail to completely check in to the system. The attendant may contact a tow truck to remove a vehicle is not properly in a parking spot if desired.

FIG. 3b illustrates a block diagram of software modules used to implement a parking lot management system 300. Parking lot management server 310 is constructed using a spot status module 312, a spot assignment module 313, a customer module 315, a payment module 314, and a network interface 311.

Parking spot device 330a-q is each constructed using a controller interface 331, a display module 333, and a sensor interface 334. The controller interface 331. The display module 333 accepts data from the management server 310 for display related to the current and upcoming use of a particular spot by a driver, The sensor interface 334 accepts input signals from sensors 19a-b and provides date for the management server 310 for monitoring the status of the spot, the arrival time and the departure time of a vehicle for use as needed.

Parking lot attendant system 320 is constructed using an alarm module 322, a payment module 323, an attendant interface module 324, and network interface module 321. The alarm module 322 detects the presence of a vehicle that has not reserved and/or checked into the facility to use a parking spot 17. When such an error is detected, the alarm module 323 may take action to address the problem. The alarm module 323 may indicate the error on the signage 10 at the parking spot 17. may send a message to an attendant informing them of the error condition, and may send a message to a towing service if desired to instruct that the wayward vehicle be moved from the parking spot 17. The payment module 323 accepts the arrival time, departure time, the customer name and address data and the customer credit card information from the customer mobile device application 340a-n when a driver is leaving a facility. This data is sent to the management server 310 to process the payment with a credit card company. The attendant interface module 324 provides input and output processing to provide an attendant with messages and data needed to perform the attendant's functions. This interface module 324 also accepts commands from the attendant to instruct the system if actions are needed to be taken. The network interface module 321 provides a communication function for the attendant's processing system to communicate with the management server 310, the parking spot devices 330a-q, and the customer mobile device application 340a-n.

Customer mobile device application 340a-n is an application on a mobile device to permit a driver to interact with the parking lot management system to make a reservation, check into a parking spot 17, check out of a parking spot 17, and make a payment for use of the parking spot. The customer mobile device application 340a-n is constructed using a user interface module 334, a parking reservation and check in module 332, a driver payment module 333, and a network interface module 331.

The user interface module 334 provides input and output processing to provide a driver with messages and data needed to perform the parking space reservations, vehicle check in and check out functions. This interface module 324 also accepts commands from the driver to instruct the application to perform these tasks.

Thea parking reservation and check in module 332 communicates with the management server 310 to make a reservation and to obtain the QRcode data and perform a check in function when the driver arrives at a parking facility. The driver payment module 333 performs the check-out functions and communicates with the attendant system 320 and management server 310 to cause payment for use of the parking spout 17 may be made using the driver's credit card information stored therein. The network interface module 331 provides a communication function for the customer mobile device application 340a-n to communicate with the management server 310, the parking spot devices 330a-q, and the attendant system 320.

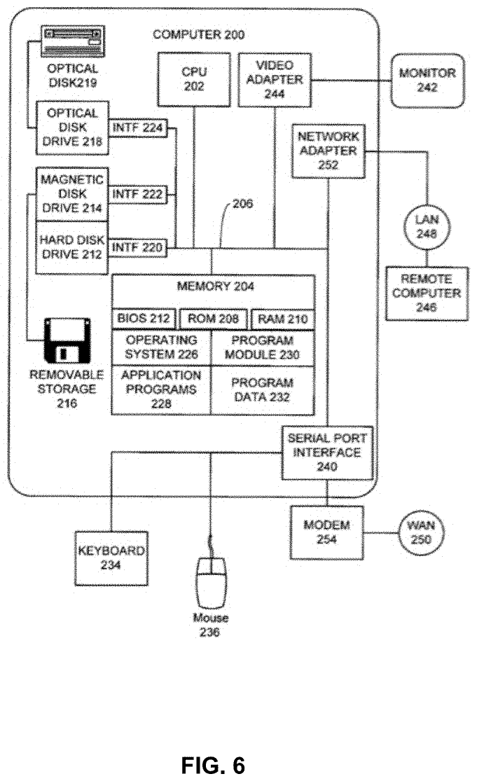

All of the computing systems described above in reference to FIGS. 3a-b may be constructed using general computing systems. An example of such computing systems are described in detail below in reference FIG. 6.

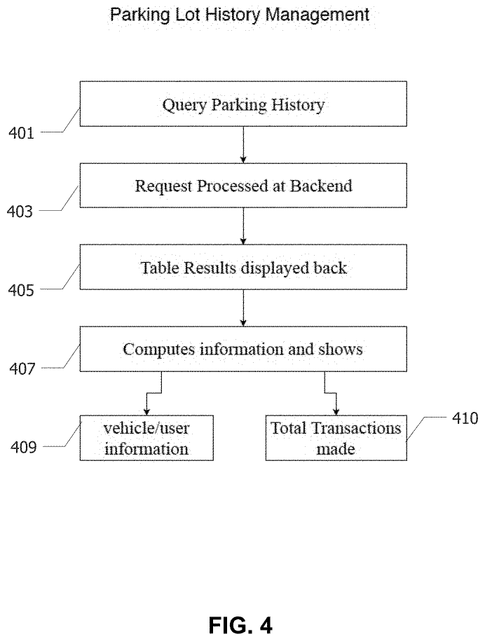

FIG. 4 illustrates a flowchart for operating steps for a customer using a smart parking space and parking lot management system according to the present invention. The parking lot system process begins with a query of parking lot history to obtain status of parking spaces in step 401. A reservation request from a driver is processed at the backend of the server 310 in step 403. A table of results of available parking spots 17 is generated for transmittal to a driver for selection in step 405. Information regarding a reserved parking spot 17 is generated in step 407. Vehicle arrival and departure information is obtained in step 409 including an encrypted QRcode that is by to the driver's mobile device that may be obtained when the driver arrives at the parking facility. Step 409 also sends information regarding the identity of the driver and related payment information to the management server 310. A finalized transaction is determined, and payment is obtained in step 410 as the process of using the parking space 17 is completed.

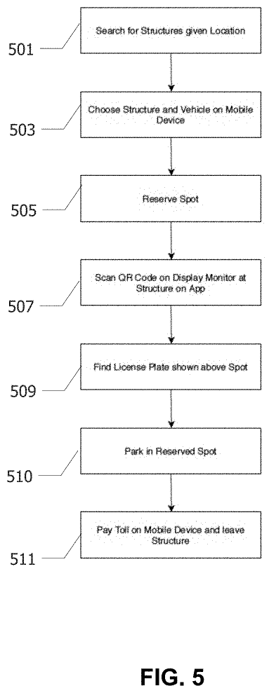

FIG. 5 illustrates a flowchart for operating steps for a parking lot system using a smart parking space and parking lot management system according to the present invention. The process of a driver obtaining and using a parking spot 17 begins in step 501 by sending a search request for available spots at a location from the mobile device 340n to server 310. The driver selects a particular spot in step 503 to make a reservation. The server 310 makes a reservation in step 505 and enters all necessary data into its database for use throughout the transaction.

When the driver arrives at the parking lot, the QRcode associated with the reservation is scanned to check in the vehicle at the parking spot 17 in step 507. Server 310 displays the driver's license plate information of a parking spot display 12 and the driver locates the assigned parking spot by finding his or her license plate number on the display in step 509. Once the spot 17 is located, the driver may park the car in step 510 and leave the vehicle for a period of time. When the driver is ready to leave the parking lot, he or she returns to the vehicle and makes a payment via the application on the mobile device 340a-n in step 511 before leaving.

FIG. 6 illustrates a generalized schematic of a programmable processing system utilized as the various computing components described herein used to implement an embodiment of the present invention.

The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RANI) 208, which may be synchronous RAM (SRAM), dynamic RAM (DRAM), synchronous dynamic RANI (SDRAM), or the like. The computer system 200 may utilize RAM 208 to store the various data structures used by a software application. The computer system 200 may also include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a parking management system, including servers, personal computers, and mobile devices as shown in FIGS. 3a and 3b. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in the testing measurements.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

What is claimed is:

1. A parking lot management system managing a plurality of parking spots in one or more parking facilities, the system comprises:
a management server;
an attendant processing system;
a plurality of parking space devices, the parking space devices having parking space sensors, a signage display, and a status light; and
a customer parking mobile application;
wherein the customer parking mobile application:
communicates with the management server to make a reservation for a parking spot from available spots;
receives QRCode data when the driver arrives at one of the one or more parking facilities;
communicates check in data and the QRCode data to the management server; and
communicates check out and payment information to the management server when departing the one of the one or more parking facilities.

2. The parking lot management system according to claim 1, wherein the management server comprises:
a spot status module for maintaining a current status for parking spots;
a spot assignment module for determining an available spot when a driver attempts to make a reservation;
a customer module creating and maintaining customer name, address and payment information for use when a driver makes a reservation and uses a parking spot;
a payment module receiving arrival time, departure time, customer name and address data and customer credit card information from the customer mobile device application when a driver is leaving a facility; and
a network interface communicating with the attendant processing system, the parking spot devices, and the customer mobile device application.

3. The parking lot management system according to claim 1, wherein the attendant system comprises:
an alarm module for detecting a presence of a vehicle that has not reserved and/or checked into the one of one or more parking facilities to use a parking spot, and when such an error is detected, taking action to address the problem;
a payment module for accepting the arrival time, departure time, the customer name and address data and the customer credit card information from the customer mobile device application when a driver is leaving a facility, and sending to the management server to process the payment with a credit card company;
an attendant interface module for providing input and output processing to provide an attendant with messages and data needed to perform the attendant's functions; and for accepting commands from the attendant to take any actions are needed; and
an attendant network interface module for communicating with the management server, the parking spot devices, and the customer mobile device application.

4. The parking lot management system according to claim 1, wherein customer parking mobile application runs on a mobile device and communicates with the management server over the Internet.

5. The parking lot management system according to claim 1, wherein customer parking mobile application includes a QRCode reader.

6. A method for providing parking lot management, the method comprising:
receiving a reservation request from a customer parking mobile application;
determining one or more available parking spots matching the reservation request;
reserving an available parking spot;
receiving a QRCode and an arrival time from the customer parking mobile application, the QRCode data is read by the customer parking mobile application at a parking facility corresponding to the reserved parking spot;
determining the vehicle in the reserved parking spot corresponds to a vehicle registered within the customer parking mobile application;
receiving a departure request and departure time from customer parking mobile application;
determining a parking fee using the arrival time and departure time for the reservation;
processing payment for the parking fee using payment data received from customer parking mobile application.

7. The method according to claim 6, wherein the customer parking mobile application runs on a mobile device and communicates with the management server over the Internet.

8. The method according to claim 6, wherein the method further comprises:
detecting a vehicle parked in a parking spot without a reservation and without a proper check in; and
transmitting a message causing a towing entity to remove the vehicle from the parking spot.

9. The method according to claim 6, wherein the method further comprises:
accepting name, address, and payment information for a driver received from the customer parking mobile application;
verifying the name, address and payment information;
receiving registered vehicle information corresponding to the driver; and
creating a user profile for the driver for use when a reservation is created, and a parking spot is used.

10. The method according to claim 6, wherein method further comprises:
upon receipt of a QRCode for a valid reservation from the customer parking mobile application, obtaining registered vehicle for the driver having the valid reservation; and
displaying the registered vehicle information on a display device at the reserved parking spot.
